(19) United States
(12) Patent Application Publication
(10) Pub. No.: US 2022/0126242 A1
(43) Pub. Date: Apr. 28, 2022

(54) METHOD OF MIXING SOLID MATERIALS, CORRESPONDING DEVICE AND USE THEREOF

(71) Applicant: CAETE PARTICIPAÇÃO E ADMINISTRAÇÃO EIRELLI, Curitiba (Paraná) (BR)

(72) Inventor: CARLOS EDUARDO FURQUIM BEZERRA, Curitiba (Paraná) (BR)

(21) Appl. No.: 17/452,390

(22) Filed: Oct. 26, 2021

(30) Foreign Application Priority Data
Oct. 27, 2020 (BR) 10 2020 022037 3

(51) Int. Cl. B01F 5/24; B01F 15/00

(52) U.S. Cl. CPC B01F 5/241; B01F 15/00344; B01F 2215/0008; B01F 5/246; B01F 15/00779

(57) ABSTRACT

A solid material mixer for mixing two or more solid materials does not require the use of external power sources and moving parts. The mixer includes at least a first chamber or tank, at least one second chamber or tank, one or more main valves and one or more mixing and homogenizing zones. The device is used in a mixing method.

### CROSS-REFERENCE TO RELATED APPLICATION

This application claims priority to Brazilian Patent Application No. 10 2020 022037 3 filed on Oct. 27, 2020, the disclosure of which including the specification, the drawings, and the claims is hereby incorporated by reference in its entirety.

### TECHNICAL FIELD

The present invention relates to the field of devices, implements and systems for the treatment, preparation, mixing and application of solid materials.

### INTRODUCTION

The present invention relates to a method of mixing solid materials without the use of any external power source, notably for the mixing of two or more powdery and/or granular materials, including agricultural materials, such as but not limited to fertilizers. The present invention also relates to a device for mixing solid materials without the use of any external power source, and a corresponding use thereof.

### BACKGROUND OF THE INVENTION

Mixing solid materials is a long-standing process for which several systems and devices have been devised.

Currently, most equipment for efficient mixing of solids uses moving parts, such as, for example, spindles, drums and blades, in addition to costly active systems already known in the prior art, which are fitted with motors powered by electrical power or various fuels. The use of moving parts causes the equipment to have many more parts and components, thus making it more demanding in terms of maintenance, requiring skilled labor that is usually extremely expensive.

In addition to making maintenance more complex and expensive, pieces of equipment with moving parts pose a constant risk to the health and life of its users and operators. It is well known that incorrect handling of equipment such as threads, pulleys, belts and the like can lead to accidents, even resulting in mutilation and death.

It should be noted that, except for extremely rudimentary equipment that uses human strength, modern equipment prioritizes the use of electric motors. The need to use electrical power imposes a limitation on the use of mixers in places where there is no nearby electrical power grid. Another problem found is the unavailability of adequate grid voltage for the operation of mixing equipment which, depending on their size, have power ratings requiring electrical currents that exceed the capacities usually installed.

This kind of issue with regard to the power grid is common in cases of implementation or use in rural properties, livestock properties, among other communities which are isolated or remote from urban centers in general.

Another problem when using electric motors is their high cost. In most equipment, motor costs represent more than 30% of the total cost of the mixing equipment and can reach more than 50% of the total cost.

Engine maintenance also requires highly skilled and costly labor. In addition to the previously discussed maintenance issues, electrical equipment also poses safety hazards as they can lead to electric shock accidents.

Finally, it is worth noting that the portability of mixing equipment is a very important and often overlooked criterion, given that most mixing equipment known in the prior art is stationary, without the possibility of easy and fast movement between points where mixing is needed.

In large rural properties, for example, materials are often required to be mixed in places that are very distant from each other and within a very short period of time, such as, for example, during planting seasons.

Due to their low mobility, several known mixing devices require special transportation equipment, with traffic restrictions on some roads or even without being able to easily travel on low-quality dirt roads.

Therefore, there is a need for a method and device for mixing solid materials that do not require the use of external power sources and that can be easily used in any suitable equipment, as will be described further below.

Furthermore, the cost of manufacturing a mixer fitted with motor, reducer and other moving parts will always be greater than the cost of manufacturing a static mixer, even allowing several pieces of equipment to be manufactured at the cost of one.

Lastly and most importantly, in the current state of the art, for a mixture of fertilizers or seeds to be carried out in remote places without electric power supply, there is a need to use a power take-off provided by a tractor or other motive equipment, or even to connect an electric mixer to an electric generator driven by an internal combustion engine. This makes the present invention extremely useful and unique, as the mixture does not rely on any external forces other than gravity.

In view of the above, a method and device that quickly and efficiently provide mixtures of tons of solid agricultural materials, without requiring significant human physical effort or the use of external power sources and which, at the same time, has no moving parts, do not rely on electrical power, has low manufacturing and maintenance costs and that also allow a portable embodiment to be manufactured, represents a significant improvement over the teachings of the prior art.

### PRIOR ART

Various solutions are known in the prior art for mixing two or more solids in such a way that the final mixture is uniform.

A pertinent prior art document is patent document U.S. Pat. No. 4,350,444 entitled “Apparatus for mixing materials such as fertilizer components” which discloses a fertilizer or feed mixing equipment including a hopper, a substantially vertical auger within the hopper and a housing enclosing the auger to form a mixing chamber. A baffle, which is attached to the casing, and the sidewall of the hopper are oriented so as to cooperatively provide a blending flow pattern within the hopper, improving the mixing of materials.

Note that, although the device of U.S. Pat. No. 4,350,444 takes advantage of the force of gravity in its mixing process, the final mechanism uses moving parts and its mixing depends mainly on the process driven by the use of electric motors. In this case, the gravitational force acts only to reduce electrical power consumption.

Other examples of the pertinent prior art that demonstrate similar disadvantages are disclosed and described by patent documents U.S. Pat. Nos. 5,395,058, 4,432,499, CN 203678285, and U.S. Pat. No. 8,651,408. In these documents, the disadvantages of active systems relying on electric motors persist, with high complexity of assembly and maintenance of their components and parts, and limited portability.

Thus, and as can be inferred from the above description, there is room for a solution capable of overcoming the deficiencies of the state of the art. Namely, a solution that provides a method that allows the efficient and effective mixing of solid materials, being exempt of the use of motors or other external power sources, regardless of their dimensions.

### Objects of the Invention

One of the objects of the present disclosure is to provide a device for mixing solid materials, according to the features of independent claim 1 of the attached set of claims.

Another object of the present disclosure is to provide a method for mixing solid materials, in accordance with the features of independent claim 10 of the attached set of claims.

Yet another object of the present disclosure is the use of a device and method for mixing solid materials, according to the features of independent claim 14 of the attached set of claims.

Other features and feature details are represented by the dependent claims.

### BRIEF DESCRIPTION OF THE FIGURES

For better understanding and visualization of the object of the present disclosure, it will now be described with reference to the attached figures, representing the technical effect obtained, wherein, schematically:

FIG. 1: shows a schematic view of a device according to the present invention, provided with a main valve;

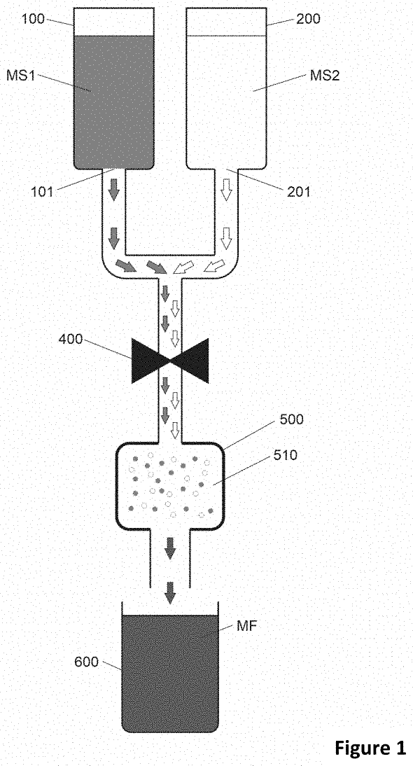

FIG. 2: shows a schematic view of an embodiment of the device in FIG. 1, provided with a main valve and premix zone;

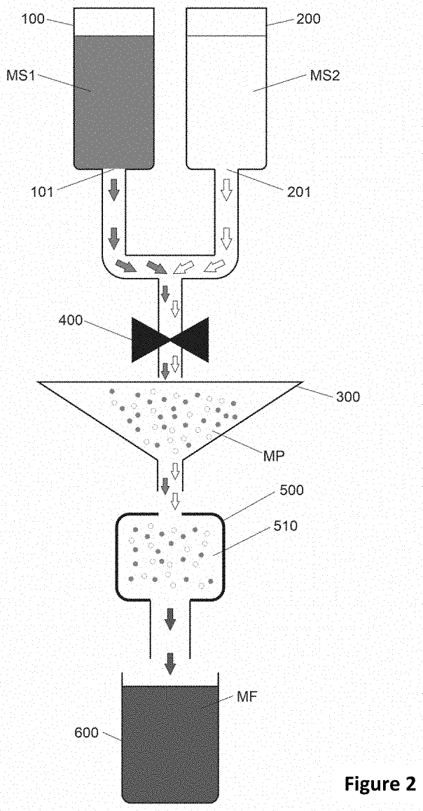

FIG. 3: shows a schematic view of an embodiment of the device in FIG. 1, provided with gates and/or flow regulators and main valve; and

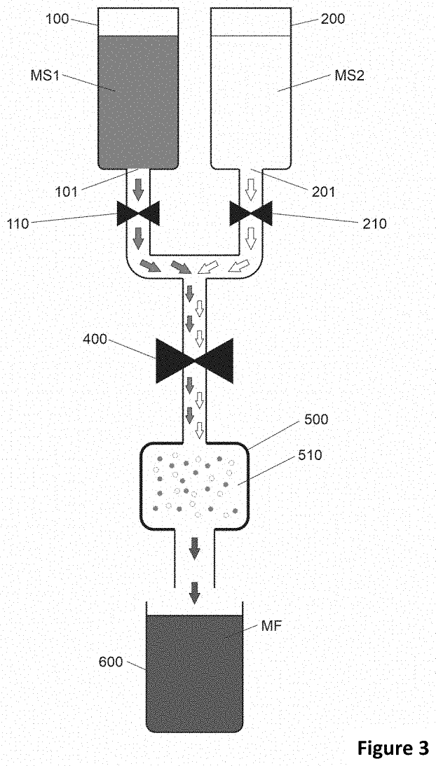

FIG. 4: shows a schematic view of an embodiment of the device in FIG. 1, provided with gates and/or flow regulators, main valve and premix zone.

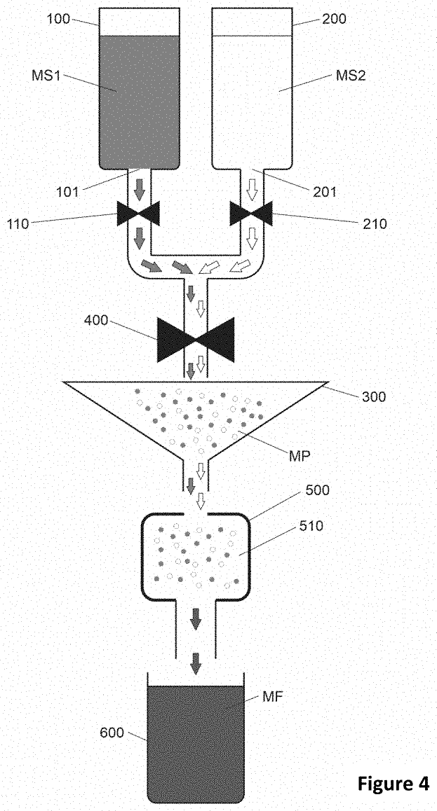

### DETAILED DESCRIPTION OF THE DISCLOSURE

### Device

The device for mixing solid materials, or simply device (10), is a device (10) for mixing two or more solid materials (MS1, MS2, . . . , MSₙ, . . . ) without the use of external power sources and moving parts, comprising:

i. at least one first chamber or tank (100);

ii. at least one second chamber or tank (200);

iii. optionally one or more gates and/or flow regulators (110, 210);

iv. one or more main valves (400);

v. optionally, one or more premix zones (300);

vi. one or more mixing and homogenizing zones (500).

The first chamber (100) has a first volume (V1) in which it receives and contains at least one first solid material (MS1). The first chamber (100) is provided with at least one opening (101), preferably arranged in its lower part, enabling the flow by gravity of the first solid material (MS1). The outlet area (A1) of the lower opening (101) is proportional to the first volume (V1) and allows the flow of the first solid material (MS1) in a first time interval (t1) at a first flow rate (v1) or first flow volume per unit of time (t1).

The second chamber (200) has a second volume (V2) in which it receives and contains at least one second solid material (MS2). The second chamber (200) is provided with at least one opening (201), preferably arranged in its lower part, enabling the flow by gravity of the second solid material (MS2). The outlet area (A2) of the lower opening (201) is proportional to the second volume (V2) and allows the flow of the second solid material (MS2) in a second time interval (t2) at a second flow rate (v2) or second flow volume per unit of time (t2).

It should be noted that the device (10) has at least two chambers (100, 200), each of which comprises one of the solid materials (MS1, MS2) to be mixed. The features described for the chambers (100, 200) will apply equivalently to any other additional chambers up to a nth chamber (n). It should be noted that the chambers (100, 200, . . . , n, . . . ) can be additional chambers and/or result from the subdivision of one or more chambers.

Furthermore, the number of chambers (100, 200), their geometric shape and/or spatial arrangement, execution materials and other appropriate features may vary, in a non-limiting manner, according to the features of the solid materials (MS1, MS2), of the process and mixing conditions and other determining features of the intended application.

Each chamber (100, 200) has at least one opening (101, 102) or outlet, which can be a simple opening and/or a pipe and/or a perforated plate and any other means suitable for the flow of the solid materials (MS1, MS2). It should be noted, therefore, that the number of openings (101, 102) as well as their geometries may vary according to the conditions of use.

In devices (10) without a flow regulation device, the chambers (100, 200) have volumes (V1, V2) proportional to the mixing percentages desired. In order to obtain the high-grade homogeneity of the invention, it is important that the flow times (t1, t2) are equal or very close to each other.

A non-limiting example of the invention can be the use of the device (10) to perform a mixture with 80% v/v of the first solid material (MS1) and 20% v/v of the second solid material (MS2). In this case, the first chamber (100) must have a first volume (V1) which is four times greater than the second volume (V2) of the second chamber (200). In a similar case with a desired ratio of 50% v/v of each solid material (MS1, Ms2), the chambers will have the same volume (V1, V2). If the intention is to make the mix ratio in wt % of the final mix (MF), mass to volume conversion should be done using the density and/or packing index of each material.

Since the openings (101, 201) are sized to ensure the constant flow of the solid materials (MS1, MS2), the devices (10) without a flow regulation device must have the openings (101, 201) sized so that the flow times (t1, t2) of each solid material (MS1, MS2) are equal, and thus the flow rates (v1, v2) will vary in an equivalent manner, in order to ensure a regular and homogeneous mixture, preceded or not by premix, that, in turn, they will allow an outstanding homogeneity of the final mixture (MF) compared to their equivalents in the prior art.

A non-limiting example of the invention can be the use of the device (10) to perform a mixture from a first chamber (100) with a volume of 800 liters and a second chamber (200) with a volume of 200 liters to make a mixture with 80% v/v of the first solid material (MS1) and 20% v/v of the second solid material (MS2) in the final product or final mixture (MF). The openings (101, 201) must be so dimensioned that the two chambers (100, 200) are emptied simultaneously, that is, the flow times (t1, t2) must be equal or close to each other.

Solid materials (MS1, MS2) can be powdery or granular materials, preferably granular. Furthermore, each solid material (MS1, MS2) can comprise a single product individually or be a mixture of two or more powdery or granular products, preferably granular.

Therefore, there may be more than one solid material, that is, up to a nth solid material (MSₙ), wherein, correspondingly, there may be up to a nth chamber (n) for this nth solid material (MSₙ).

Since the essential features of the solid materials (MS1, MS2, . . . , MSₙ, . . . ) can be different from each other, such as, for example, particle size, density, weight etc., the flow velocities (v1, v2, . . . , vₙ, . . . ) will also be different to ensure that the flow times (t1, t2, . . . , tn, . . . ) are equal or close to each other.

It should be noted, once again, that the ideal non-limiting condition of the device (10) according to the invention is that the flow times (t1, t2) are preferably equal to each other, to ensure a regular and homogeneous mixture, preceded or not by premix, which, in turn, will enable an outstanding homogeneity compared to their equivalents in the prior art.

Furthermore, the mixing instructions of the manufacturers of each solid material and/or the values determined by the user's experience must be observed.

That said, there may be, according to the individual features of each solid material (MS1, MS2) and the desired mixing conditions, the need to individually control (increase, maintain or decrease) the flow rates (v1, v2), wherein one or more of the chambers (100, 200) may have at least one or more gates and/or flow regulators (110, 210) for releasing and/or regulating the flow of solid materials (MS1, MS2).

The gates and/or flow regulators (110, 210) can be of the simple, open-close, or variable opening type or a combination of simple and adjustable opening types, in order to open and close (simple type) and also enable the fine adjustment of flow time (adjustable type), which can be valves, perforated sheets, profiles etc., being an optional item that can be dispensed with in cases where there is no need for high accuracy in the ratio of solid materials (MS1, MS2) in the final product and/or the flow times of the solid materials (MS1, MS2) are known and without large flow variations. However, as the variable opening types allow the adjustment of the flow times of one or more solid materials (MS1, MS2), they are useful to expand the possibilities of mixing ratios and also the range of the solid materials (MS1, MS2) that can be mixed.

In another non-limiting example of the invention, the device (10) for performing a mixture has a first chamber (100) with 200-liter capacity and a second chamber (200) with 800-liter capacity that are emptied in 60 seconds. Without the gates and/or flow regulators (110, 210), if both chambers (100, 200) are completely filled with solid materials (MS1, MS2), the two chambers will be fully emptied in 60 seconds, achieving a final product with 20% of the first solid material (MS1) and 80% of the second solid material (MS2). Assuming that the second solid material (MS2) has a variable flow rate and the second chamber (200), despite being designed to drain in 60 seconds, completely drains in 50 seconds. With a second gate (210), it will be possible to restrict the flow of the second solid material (MS2), causing it to drain within the expected 60 seconds, thus ensuring the desired percentage in the final product. Another possibility with the adjustment option is to change the mixing ratios, restricting one or two or more products.

It should be noted that, if at least one of the flow times (t1, t2) is previously known (reference time), it is enough to use only one of the gates and/or flow regulators (110, 210) with variable opening or even to dimension the openings (101, 201) so that the ratios of the final mixture (MF) are obtained without the need for any type of adjustment.

Likewise, if all the flow times (t1, t2) are previously known, the use of gates and/or flow regulators (110, 210) with variable opening is dispensed with.

The premix zone (300) is an optional intermediate portion of the device (10), arranged between the chambers (100, 200) and the mixing and homogenizing zone (500), its use being dependent on the geometry of the chambers (100, 200), the geometry of the openings (101, 201) and the distance between the openings (101, 201), that is, it also depends on the paths that solid materials (MS1, MS2) travel, and may be arranged upstream or downstream of a main valve (400) of the simple (open-close) or adjustable-opening type.

After determining the flow time (t1, t2) and/or the appropriate opening percentage of each of the gates and/or flow regulators (110, 210) of the chambers (100, 200), the opening of one or more of the gates and/or flow regulators (110, 210), if present, or the main valve (400) takes place, thereby releasing the flow of the solid materials (MS1, MS2) to the premix zone (300) or directly to the mixing and homogenizing zone (500). In case a premix zone (300) is provided, a first crossing of the streams will occur in it, thereby forming a preliminary, not yet homogeneous mixture (MP) of the solid materials (MS1, MS2) which will then proceed to the mixing and homogenizing zone (500).

The main purpose of the premix zone (300) is therefore to direct the particles from the two or more chambers (100, 200) against each other, forcing the solid materials (MS1, MS2) streams to be mixed together. It can be made out of cones, fixed spreaders, plates, inverted cones etc. The premix zone (300) can consist of one part or several parts and even have more than one premix zone (300) connected in series. When the main valve (400), if present, is arranged downstream of the premix zone (300) and closed, the flow of material will cease as soon as the premix zone (300) is full.

When the main valve (400), if present, is open, the flow of the preliminary mixture (MP) will proceed towards the mixing and homogenizing zone (500).

The mixing and homogenizing zone (500) conducts the mixing of the solid materials (MS1, MS2) by directing them through a mixing and homogenizing chamber (510). This, in turn, must be provided with elements capable of making the preliminary mixture (PM) flow change direction several times, promoting a turbulent flow and thus improving the mixture homogenization.

For this purpose, the mixing and homogenizing zone (500) can be provided with one or more turbulence elements that can be chosen, in a non-limiting manner, from the group consisting of straight, inclined, oblique, parallel, helical and variably shaped bulkheads or barriers, individually or together with one or more of these shapes. These elements can also be mounted radially, axially, individually at levels or in pairs, at angles to each other.

In this way, the preliminary mixture (PM) of the solid materials (MS1, MS2) falls by gravity onto the turbulence elements of the mixing and homogenizing chamber (510) and, therefore, leaves the device (10) and flows into a suitable container (600).

It should be noted that there may be more than one mixing and homogenizing zone (500), and they may be connected in series.

### Method

A method of mixing solid materials, according to the present invention, is a method performed by a device (10) according to the invention, comprising the following method steps:
I. placing a first solid material (MS1) in the first chamber (100) of the device (10);
II. placing a second solid material (MS2) in the second chamber (200) of the device (10);
III. determining the flow time (t1) of the first solid material (MS1);
IV. determining the flow time (t2) of the second solid material (MS2);
V. defining one of the flow times (t1, t2) as the reference time;
VI. adjusting the dimensions of the openings (101, 201) in order to ensure that the flow times (t1, t2) are equal or close to each other, preferably equal or close to the reference time;
VII. fully or partially opening the main valve (400), thereby releasing the flow of solid materials (MS1, MS2);
VIII. optionally conducting the pre-mixing of the solid materials (MS1, MS2) in a premix zone (300) arranged upstream of the mixing and homogenizing zone (500), thereby forming a preliminary mixture (MP);
IX. conducting several changes of direction of the solid materials (MS1, MS2) or, optionally, of preliminary mixture (MP), in a mixing and homogenizing zone (500), promoting a turbulent flow and thus improving the mixture homogenization; and
X. optionally collecting the final mixture (MF) at the outlet of the mixing and homogenizing zone (500) in a container (600).

It is noteworthy that the performance of step VI, regarding the adjustment of the dimensions of the openings (101, 201), can be done both by using gates and/or flow regulators (110, 210) with variable opening percentages and geometries, as well as by dimensioning and constructing the openings (101, 201) so as to adapt them to the flow times (t1, t2) in the case of absence of gates and/or flow regulators (110, 210).

It will be evident to the person skilled in the art that the method according to the present invention can be applied in various manners, without being restricted to the illustrated embodiments. Thus, the device (10) and method of the present disclosure can be used for mixing other solid materials such as animal feed or building materials.

### Use

The use according to the invention refers to the use of a device according to the invention for performing a method according to the invention for obtaining a final mixture (MF) of solid materials (MS1, MS2).

### Final Considerations

Thus, it should be noted that the present invention covers several technical fields, allowing for versatile, economic, sustainable and practical implementations.

### CONCLUSION

It will be readily understood by those skilled in the art that modifications can be made to the present invention without thereby departing from the concepts set out in the description above. Such modifications are to be considered within the scope of the present disclosure. Accordingly, the particular embodiments described in detail above are only illustrative and exemplary and do not limit the scope of the present invention, to which the full extent of the appended claims and any and all equivalents thereto should be applied.

What is claimed is:

1. A device for mixing solid materials for mixing two or more solid materials without the use of external power sources and moving parts, comprising:
i. at least one first chamber or tank;
ii. at least one second chamber or tank;
iii. one or more main valves;
iv. one or more mixing and homogenizing zones.

2. The device according to claim 1, further comprising one or more gates and/or flow regulators.

3. The device according to claim 2, wherein the one or more of the gates and/or flow regulators are of the simple, open/close or variable opening type, or even a combination of simple and adjustable opening types.

4. The device according to claim 1 further comprising one or more premix zones.

5. The device according to claim 4,
wherein the premix zone is an intermediate portion arranged between the chambers and the mixing and homogenizing zone, and
wherein its use depends on the geometry of the chambers, the geometry of the openings and the distance between the openings.

6. The device according to claim 1 further comprising one or more gates and/or flow regulators and one or more premix zones.

7. The device according to claim 1, wherein the chambers have volumes that receive and contain solid materials, having lower openings enabling the gravity-induced flow of the solid materials, in which the outlet areas of the lower openings are proportional to the volumes, allowing the flow of the solid materials at time intervals which are equal or close to each other.

8. The device according to claim 1, wherein the mixing and homogenizing zone conducts the mixing of the solid materials per se by passing them through a mixing and homogenizing chamber fitted with elements capable of causing the flow of the solid materials and/or the preliminary mixture to change direction several times, promoting a turbulent flow and thus improving the mixture homogenization.

9. The device according to claim 8,
wherein the mixing and homogenizing zone is provided with one or more turbulence elements that can be chosen, in a non-limiting manner, from the group consisting of straight, inclined, oblique, parallel, helical and variably shaped bulkheads or barriers, individually or together with one or more of these shapes, and
wherein the one or more turbulence elements may be mounted radially, axially, individually at levels or in pairs, at angles to each other.

10. A method for mixing solid materials comprising providing the device according to claim 1.

11. The method according to claim 10 further comprising:
I. placing a first solid material in the first chamber of the device;
II. placing a second solid material in the second chamber of the device;
III. determining the flow time of the first solid material;
IV. determining the flow time of the second solid material;
V. defining one of the flow times as the reference time;
VI. adjusting the dimensions of the openings in order to ensure that the flow times are equal or close to each other, preferably equal or close to the reference time;
VII. fully or partially opening the main valve, thereby releasing the flow of solid materials;
VIII. optionally conducting the pre-mixing of the solid materials in a premix zone arranged upstream of the mixing and homogenizing zone, thereby forming a preliminary mixture;
IX. conducting several changes of direction of the solid materials or, optionally, of preliminary mixture, in a mixing and homogenizing zone, promoting a turbulent flow and thus improving the mixture homogenization; and
X. optionally collecting the final mixture at the outlet of the mixing and homogenizing zone in a container.

12. The method according to claim 11, wherein the adjustment of the dimensions of the openings is made by using gates and/or flow regulators with variable opening percentages and geometries.

13. The method according to claim 11, wherein the adjustment of the dimensions of the openings, in the absence of gates and/or flow regulators, is made by sizing and constructing the openings so as to adapt them to the flow times.

14. A final mixture of solid materials produced by the method according to claim 10.
